(19) United States
(12) Patent Application Publication
(10) Pub. No.: US 2024/0235106 A1
(43) Pub. Date: Jul. 11, 2024

(54) Connection system for a power line

(71) Applicant: Hilti Aktiengesellschaft, Schaan (LI)

(72) Inventors: Michael REINER, Schwabmünchen (DE); Leonard JANCZYK, Eresing (DE); Si WANG, Untermeitingen (DE); Kay PASZEHR, Woerthsee (DE); Karl-Heinz HOFMANN, Weil (DE)

(21) Appl. No.: 18/561,477

(22) PCT Filed: Jun. 8, 2022
(86) PCT No.: PCT/EP2022/065508

§ 371 Date: Nov. 16, 2023

(30) Foreign Application Priority Data
Jun. 11, 2021 (EP) 21179034.0

(51) Int. Cl. H01R 13/58; H01R 4/28; H01R 13/595

(52) U.S. Cl. CPC H01R 13/5825; H01R 4/28; H01R 13/5833; H01R 13/595

(57) ABSTRACT

Connection system, in particular for a charger or a power tool, containing a connection plug with a power line and containing a socket apparatus with at least one socket element for releasable connection to the connection plug. The socket apparatus contains a first strain-relief device in order to counteract a tensile load, exerted on the power line, when the connection plug and the socket element are in a connected state. Charger with a connection system containing a connection plug with a power line and containing a socket apparatus with at least one socket element for releasable connection to the connection plug. Power tool with a connection system containing a connection plug with a power line and containing a socket apparatus with at least one socket element for releasable connection to the connection plug. Socket apparatus with at least one socket element for releasable connection to a connection plug for a connection system.

The present invention relates to a connection system, in particular for a charger or a power tool, containing a connection plug with a power line and containing a socket apparatus with at least one socket element for releasable connection to the connection plug.

Furthermore, the present invention relates to a charger with a connection system containing a connection plug with a power line and containing a socket apparatus with at least one socket element for releasable connection to the connection plug.

Furthermore, the present invention relates to a power tool with a connection system containing a connection plug with a power line and containing a socket apparatus with at least one socket element for releasable connection to the connection plug.

The present invention further relates to a socket apparatus with at least one socket element for releasable connection to a connection plug for a connection system, in particular for a charger or a power tool.

### BACKGROUND

Power cables, which can also be referred to as power lines, are largely known from the prior art and can be used, for example, to be connected to a power tool or a charger in order to supply the power tool or the charger with electrical energy. The charger meant in this context is used to charge one or more rechargeable batteries (also called storage batteries) with electrical energy.

### SUMMARY OF THE INVENTION

The power cables and the apparatuses for connecting the power cable to a power tool or a charger are usually configured to be relatively robust in order to also counteract high mechanical stresses, wear and damage from use and to remain functional. Nevertheless, improper handling can result in damage to the power cable, which makes it necessary to replace the power cable in order to continue to use the power tool or the charger safely.

However, replacing or even just detaching or removing a power cable according to the prior art is often relatively difficult or even impossible. As a result, it is often necessary for the power tool or the charger to be taken to a specialist in a specialist company so that the damaged power cable can be replaced. Accordingly, the power tool or charging device is not available to a user for the duration of the repair or replacement of the power cable.

An object is therefore to solve the problem described above or to provide a connection system, in particular for a charger or a power tool, containing a connection plug with a power line and containing a socket apparatus with at least one socket element for releasable connection to the connection plug, a charger with a connection system containing a connection plug with a power line and containing a socket apparatus with at least one socket element for releasable connection to the connection plug, a power tool with a connection system containing a connection plug with a power line and containing a socket apparatus with at least one socket element for releasable connection to the connection plug or containing a socket apparatus with at least one socket element for releasable connection to a connection plug for a connection system, in particular for a charger or a power tool, with which the problem described above can be solved.

The present invention provides a connection system, in particular for a charger or a power tool, containing a connection plug with a power line and containing a socket apparatus with at least one socket element for releasable connection to the connection plug.

According to the invention, a socket apparatus contains a first strain-relief device in order to counteract a tensile load, exerted on the power line, when the connection plug and the socket element are in a connected state.

According to an advantageous embodiment of the present invention, it may be possible for the socket apparatus to contain a second strain-relief device. As a result, the power line can be additionally secured against a tensile load.

According to an advantageous embodiment of the present invention, it may be possible for the second strain-relief device to be configured substantially as an arcuate groove for receiving at least a partial section of the power line. As a result, the power line can be secured against tensile loading in a simple manner.

According to an advantageous embodiment of the present invention, it may be possible for the second strain-relief device to be configured substantially as a self-sealing grommet with a substantially central cutout for the power line to pass through.

According to an advantageous embodiment of the present invention, it may be possible for the second strain-relief device to be configured substantially as a screwing device with a clamping element for releasably clamping the power line. It is also possible here for the screwing device to be additionally used for releasable connection of a first and a second housing part, the screwing device being guided through the first housing part to the second housing part through a corresponding screw hole.

According to an advantageous embodiment of the present invention, it may be possible for a cover device to be included, wherein the cover device contains the second strain-relief device and is configured to at least partially cover the socket apparatus. As a result, the function of covering the socket apparatus and the function of relieving strain on the power line can be effectively combined with one another.

Furthermore, the present invention provides a charger with a connection system containing a connection plug with a power line and containing a socket apparatus with at least one socket element for releasable connection to the connection plug.

Furthermore, the present invention provides a power tool with a connection system containing a connection plug with a power line and containing a socket apparatus with at least one socket element for releasable connection to the connection plug.

The present invention also provides a socket apparatus with at least one socket element for releasable connection to a connection plug for a connection system, in particular for a charger or a power tool.

### BRIEF DESCRIPTION OF THE DRAWINGS

Further advantages will become apparent from the following description of the figures. Various exemplary embodiments of the present invention are illustrated in the figures. The figures, the description and the claims contain numerous features in combination. A person skilled in the art will expediently also consider the features individually and combine them to form useful further combinations.

Identical and similar components are denoted by the same reference signs in the figures, in which:

FIG. 1 shows a perspective view of the bottom side of a housing of a charger;

FIG. 2 shows a perspective view of a socket apparatus with a socket element;

FIG. 3 shows a first perspective view of the socket apparatus with the socket element and the connection plug with a power line;

FIG. 4 shows a second perspective view of the socket apparatus with the socket element and the connection plug with the power line;

FIG. 5 shows a third perspective view of the socket apparatus with the socket element and the connection plug with the power line;

FIG. 6 shows a first perspective view of the socket apparatus with a cover device;

FIG. 7 shows a second perspective view of the socket apparatus with the cover device;

FIG. 8 shows a third perspective view of the socket apparatus with the cover device;

FIG. 9 shows a first perspective view of an inside of the cover device with a second strain-relief device;

FIG. 10 shows a second perspective view of the inside of the cover device with the second strain-relief device;

FIG. 11 shows a third perspective view of the inside of the cover device with the second strain-relief device;

FIG. 12 shows a first perspective view of the connection plug with part of the power line;

FIG. 13 shows a second perspective view of the connection plug with part of the power line; and

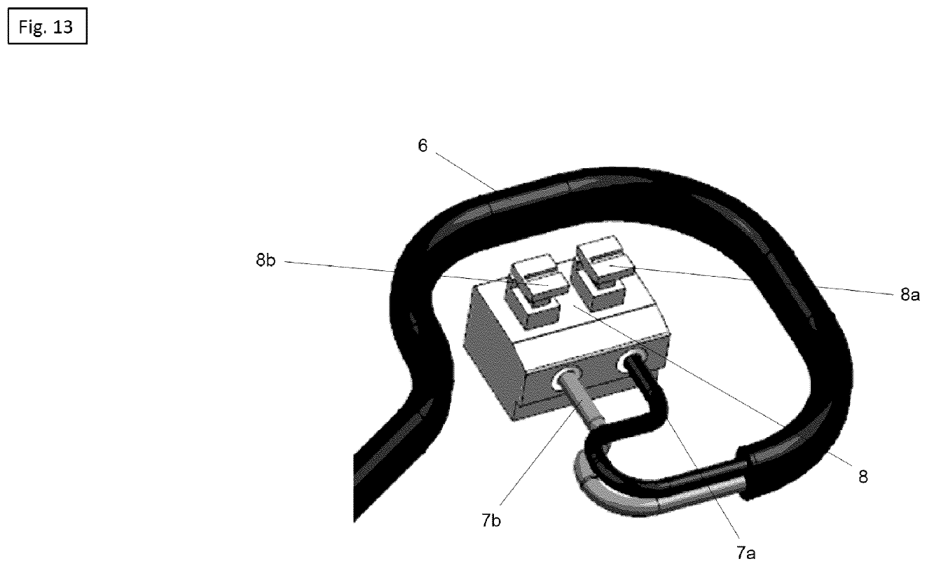

FIG. 14 shows a third perspective view of the connection plug with part of the power line.

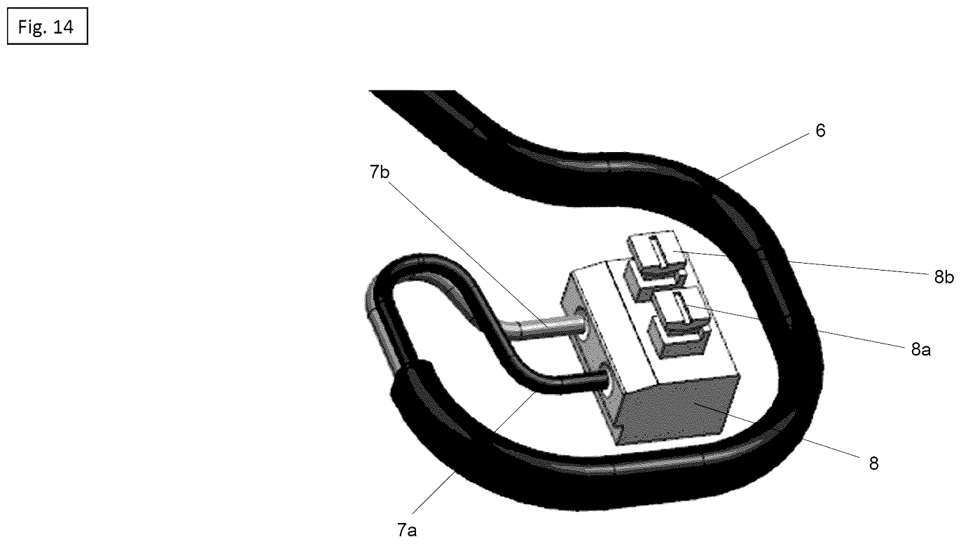

### DETAILED DESCRIPTION

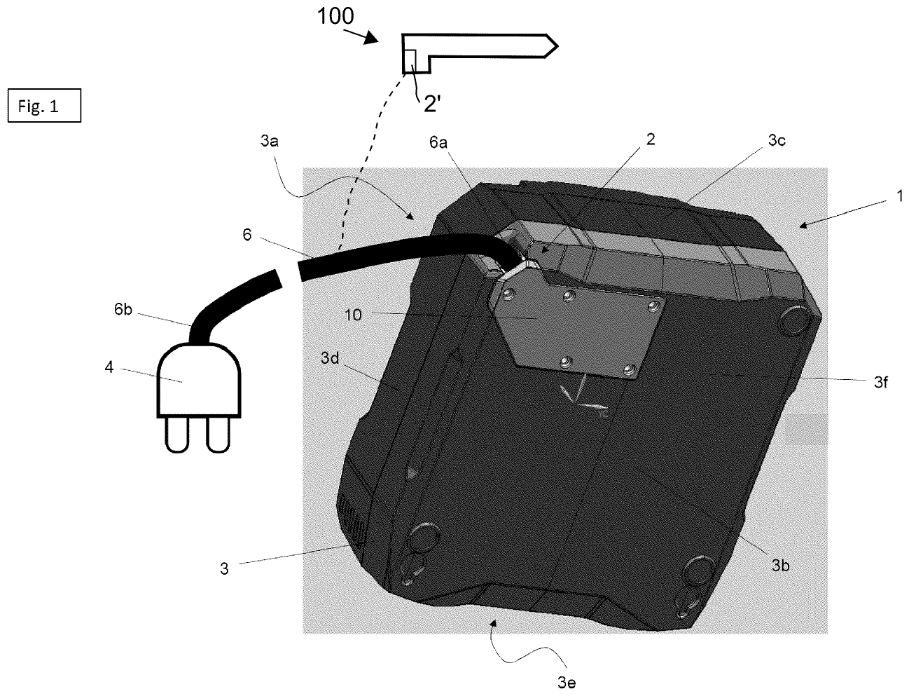

FIG. 1 shows a charger 1 with a first exemplary embodiment of a connection system 2 according to the invention.

The charger 1 is used here to charge a rechargeable battery with electrical energy.

Instead of the charger 1, the connection system 2 according to the invention can also be positioned on a power tool. The power tool 100 with a connection system 2′ shown solely schematically as an alternative shown solely schematically as alternative in FIG. 1.

The charger 1 illustrated in FIG. 1 substantially contains a housing 3, a control apparatus, a rechargeable battery interface and the connection system 2 according to the invention.

The housing 3 of the charger 2 in turn contains a top side 3a, a bottom side 3b and a first, a second, a third and a fourth side wall 3c, 3d, 3e, 3f.

The top side 3a and two side walls 3e, 3f are not shown in the figures and are merely indicated. The rechargeable battery interface is positioned on the top side 3a of the housing 3. The rechargeable battery interface is used to releasably connect a rechargeable battery to the charger 1. In a state in which the rechargeable battery is connected to the charger 1, electrical energy can pass from the charger 1 to the rechargeable battery and can be stored in the rechargeable battery.

The control apparatus is positioned in the interior of the housing 3 and is used to control and regulate the various functions of the charger 1. The functions of the charger 1 include, amongst other things, the need-based adjustment of the electrical energy that is intended to reach a rechargeable battery connected to the charger 1.

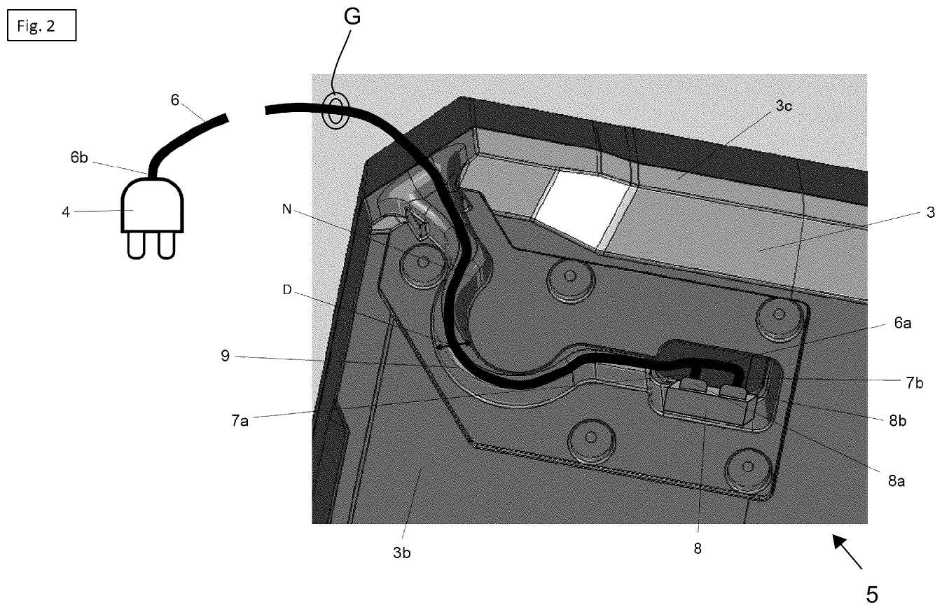

The connection system 2 shown in FIGS. 1 and 2 according to the first exemplary embodiment is positioned at an outer edge or corner of the bottom side 3b of the housing 3 of the charger 1. According to an alternative exemplary embodiment, the connection system 2 according to the invention can also be positioned in the middle (or in the center) of the flat bottom side 3b of the housing 3.

As shown in FIG. 2, the connection system 2 according to first embodiment substantially contains a connection plug 4 and a socket apparatus 5. The connection plug 4 is in turn connected to a power line 6 (also called power cable). In this case, the power line 6 has a first end 6a and a second end 6b. The first end 6a of the power line 6 is connected to the connection plug 4. The connection plug 4 in turn contains a first line 7a and a second line 7b. The first line 7a can also be referred to as an outer conductor or phase. The second line 7b can also be referred to as a neutral conductor.

A mains plug (also called a socket plug) for a mains power source (also called a socket) is positioned at the second end 6b of the power line 6.

The socket apparatus 5 contains a socket element 8 for releasable connection to the connection plug 4. Instead of a single socket element 8, two or more socket elements can also be provided. In this case, a socket element 8 contains at least one connection 8a for the first line 7a and one connection 8b for the second line 7b.

The connection plug 4 is configured to be releasably connected to the socket element 8. For this purpose, the first line of the connection plug 4 is connected to the connection 8a for the first line 7a and the second line 7b of the connection plug 4 is in turn connected to the connection 8b for the second line 7b. The connection of the first line 7a to the connection 8a for the first line 7a and the connection of the second line 7b to the connection 8b for the second line 7b are configured as plug-in connections. According to an alternative exemplary embodiment, the connections can also be configured as clamp connections.

Furthermore, the socket apparatus 8 contains a first strain-relief device 9. The strain-relief device 9 (also called a cable lock or cable stopper) serves to counteract a tensile load (or tensile force) exerted on the power line 6 and to prevent the power line 6 from being unintentionally pulled out of the socket apparatus 8.

As can be seen in FIG. 2, the first strain-relief device 9 according to the first exemplary embodiment of the connection system 2 according to the invention is configured as an arcuate groove N for receiving a partial section of the power line 6. The arc shape of the groove is substantially C-shaped here. FIG. 2 also shows, solely schematically, a self-sealing grommet G as an other possible strain reliever.

As an alternative, the arc shape of the groove N can also be of S-shaped configuration.

The arcuate groove N can also be referred to as a channel or recess. The arcuate groove N has a substantially uniform diameter (or width) D which corresponds approximately to the diameter (or the width) of the power line 6, so that a partial region of the power line 6 can be inserted into the arcuate groove N with a precise fit. Owing to the accuracy of fit, the partial region of the power line 6 is connected to the arcuate groove N in a force-fitting manner. Due to the arc shape of the groove N, a larger proportion of the power line 6 can be positioned in the strain-relief device 9, configured as a groove N, and consequently a greater tensile load can be counteracted than with a straight groove N.

Furthermore, the socket apparatus 5 contains a cover device 10, cf. FIG. 1. The cover device 10 serves to cover the socket apparatus 5 and in this way to protect the socket apparatus 5 and the individual constituent parts of the socket apparatus 5 from mechanical stresses and/or contamination. As can be seen in the figures, the cover device 10 is arranged pivotably with respect to the socket apparatus 5 by way of a hinge 11, so that the socket apparatus 5 can be closed by correspondingly pivoting closed the cover device 10. FIG. 1 shows the socket apparatus 5 with the cover device 10 in a closed state. FIG. 2 shows the socket apparatus 5 without the cover device 10.

Furthermore, the cover device 10 contains a second strain-relief device 12. In this case, the second strain-relief device 12 is positioned on a bottom side of the cover device 10 and is configured substantially as a clamping element at one end of the cover device 10 for releasably clamping the power line 6. The second strain-relief device 12, configured as a clamping element, according to the first exemplary embodiment is not shown in the figures.

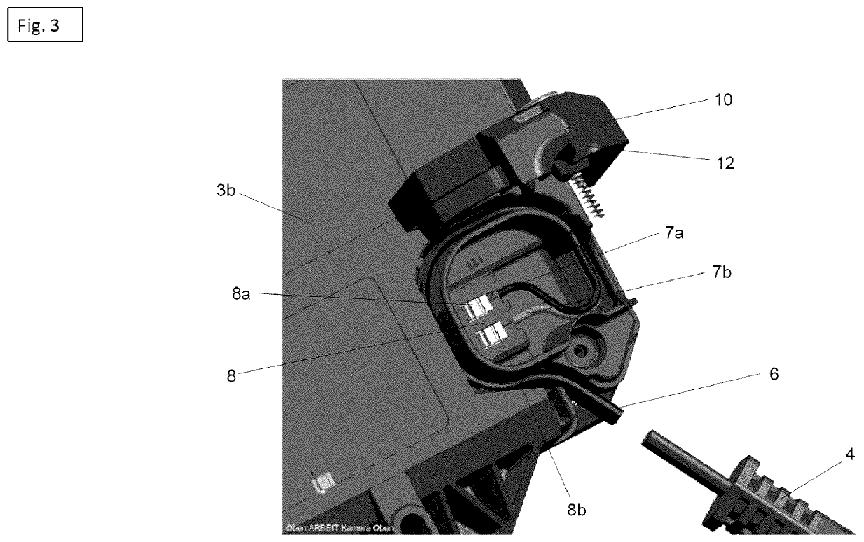

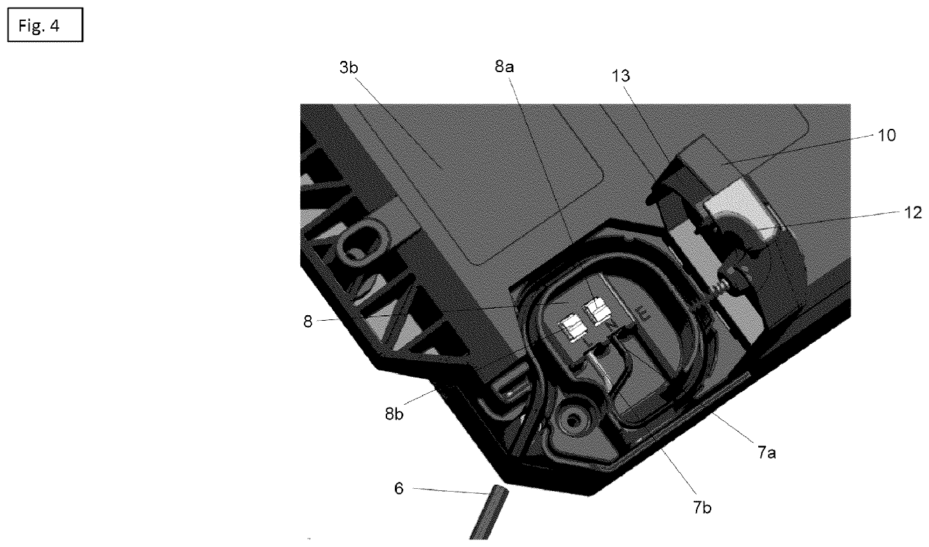

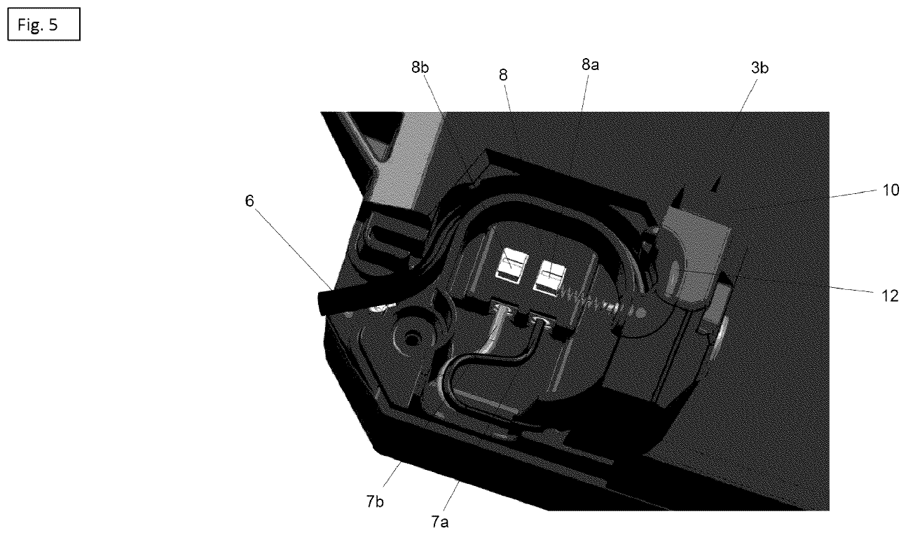

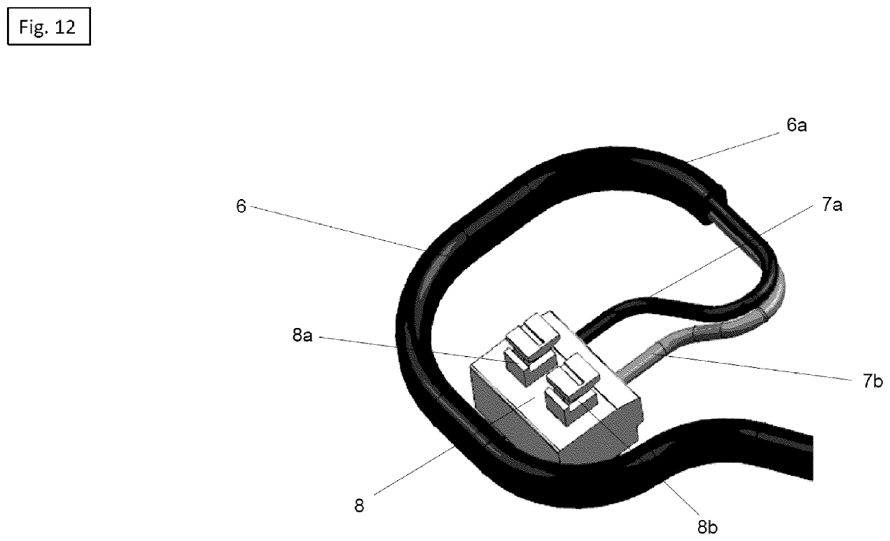

The connection system 2 according to a second exemplary embodiment of the invention is illustrated in FIGS. 3 to 5. The connection system 2 according to the second exemplary embodiment is substantially identical to the connection system 2 according to the first exemplary embodiment. In contrast to the first exemplary embodiment, the first strain-relief device 9 is not configured in the form of a C-shaped or simply bent groove N, but rather as a completely bent groove N. In other words: the first strain-relief device 9, configured as a groove N, is positioned substantially along an outer edge of the socket apparatus 5. In contrast to the first exemplary embodiment, the first strain-relief device 9 is configured to be longer and thus provides a power line 6 inserted into the slot N with greater strain relief. FIGS. 12. 13 and 14 show perspective views of part of the connection plug 4 connected to socket element 8.

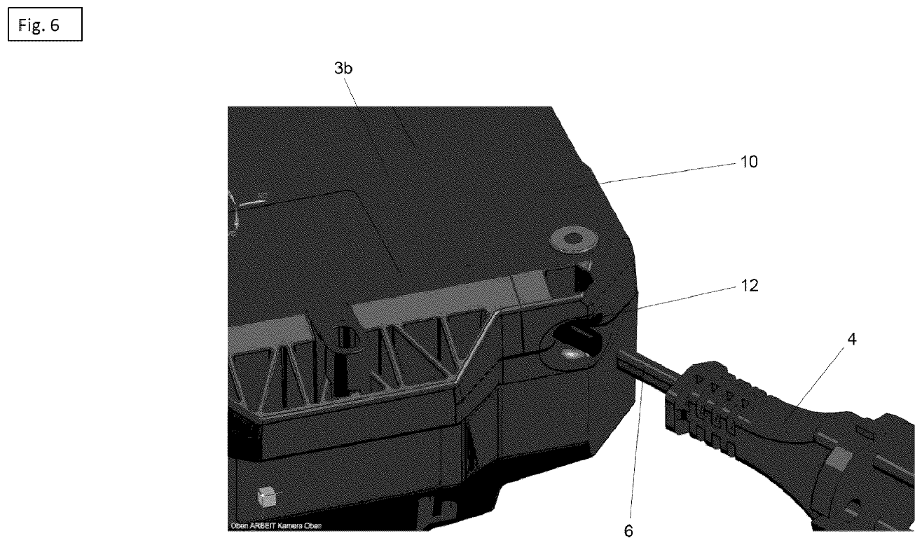

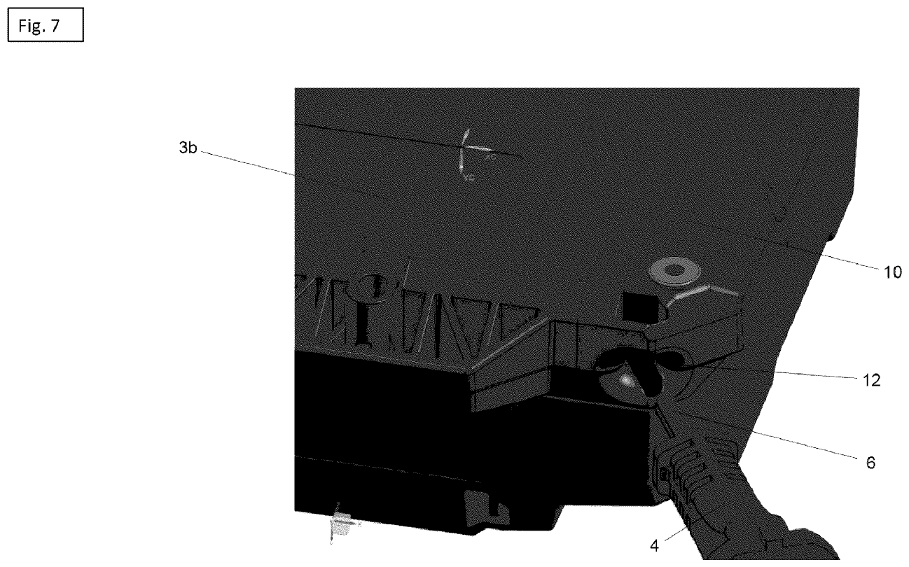

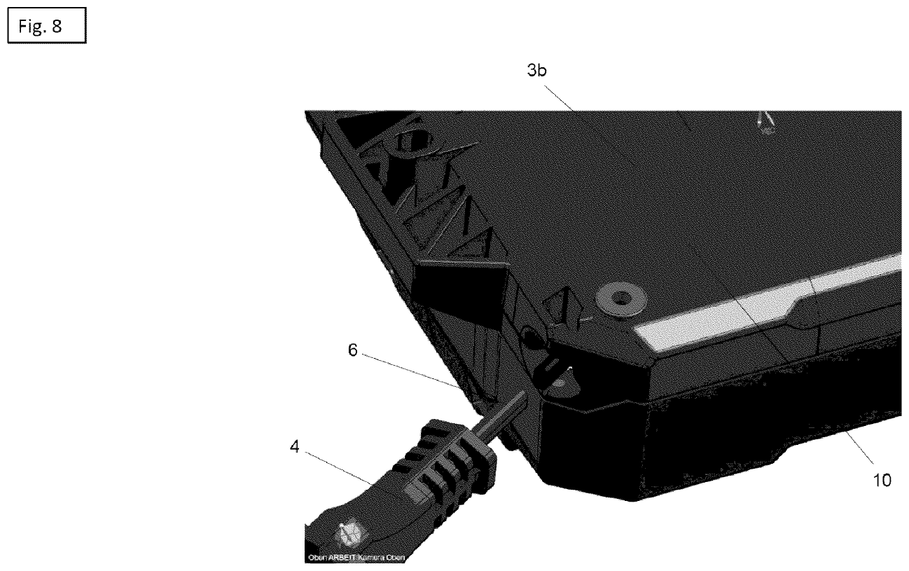

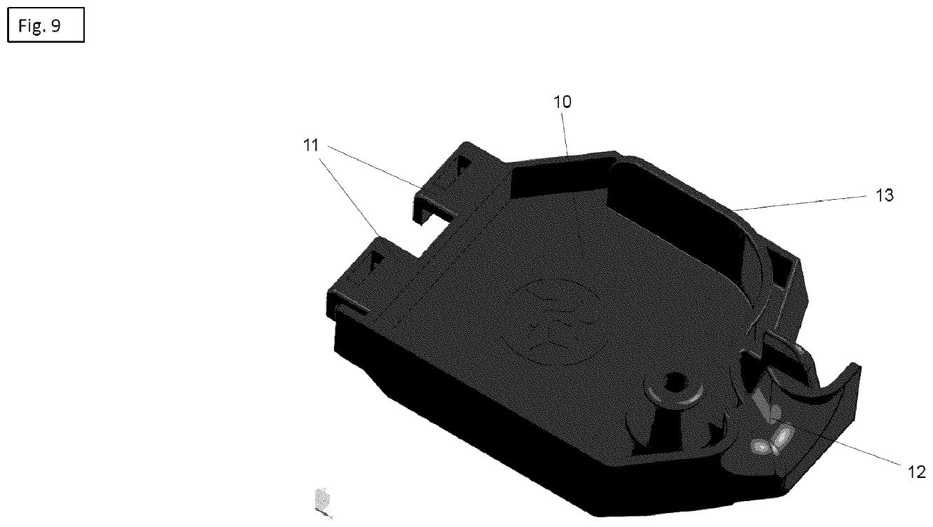

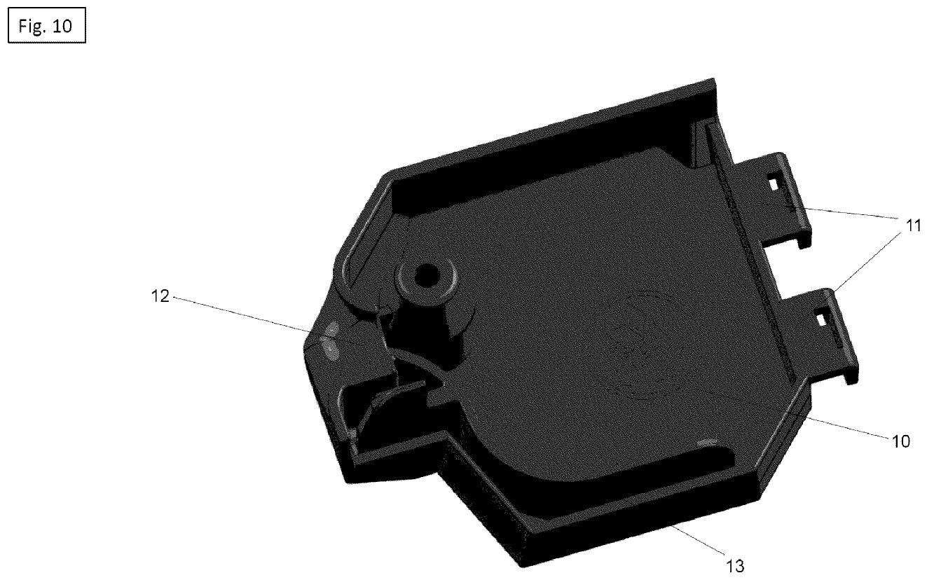

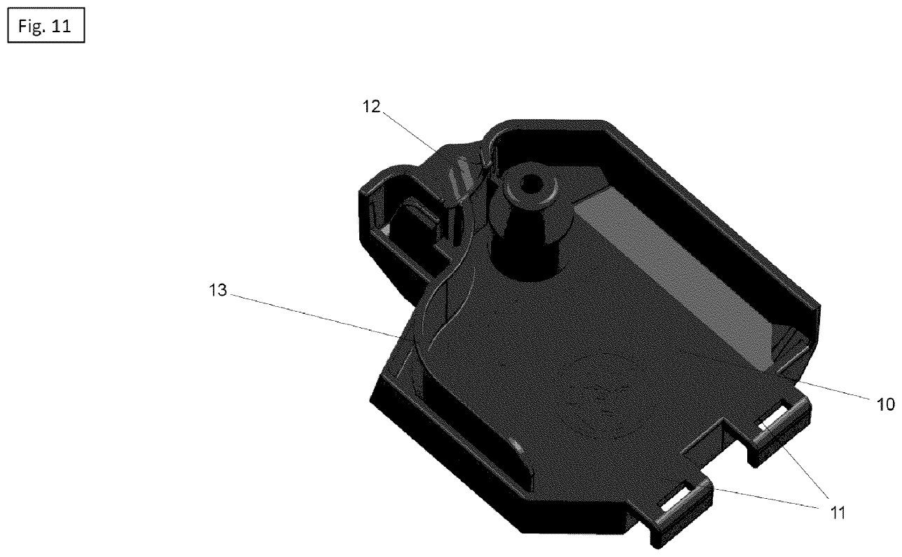

The cover device 10 according to the second exemplary embodiment is illustrated in FIGS. 9 to 11. A second strain-relief device 12 is positioned on the bottom side of the cover device 10. In contrast to the first exemplary embodiment, the second strain-relief device 12 is configured in the form of an S-shaped raised portion 13 which corresponds to a part of the first strain-relief device 9, configured as a groove N, or to this part of the groove N. When the cover device 10 is in a closed state and the cover device 10 covers the socket apparatus 8 (cf. FIGS. 6 to 8), the second strain-relief device 12, configured as a raised portion 13, rests on the power line 6, which is located in the first strain-relief device 9, configured as a groove N. The second strain-relief device 12, configured as a raised portion 13, exerts additional strain relief on the inserted power line 6 as a result.

### LIST OF REFERENCE SIGNS

1 Charger
2 Connection system
3 Housing
3a Top side of the housing
3b Bottom side of the housing
3c First side wall
3d Second side wall
3e Third side wall
3f Fourth side wall
4 Connection plug
5 Socket apparatus
6 Power line
6a First end of the power line
6b Second end of the power line
7a First line
7b Second line
8 Socket element
8a Connection for the first line
8b Connection for the second line
9 First strain-relief device
10 Cover device
11 Hinge
12 Second strain-relief device
13 Raised portion
D Diameter of the groove
N Groove

1-9. (canceled)

10. A connection system comprising:
a connection plug with a power line; and
a socket apparatus with at least one socket element for releasable connection to the connection plug, the socket apparatus containing a first strain-reliever in order to counteract a tensile load, exerted on the power line, when the connection plug and the socket element are in a connected state.

11. The connection system as recited in claim 10 wherein the socket apparatus contains a second strain-reliever.

12. The connection system as recited in claim 11 wherein the second strain-reliever is configured as an arcuate groove for receiving at least a partial section of the power line.

13. The connection system as recited in claim 11 wherein the second strain-reliever is configured a self-sealing grommet with a central cutout for the power line to pass through.

14. The connection system as recited in claim 11 wherein the second strain-reliever is configured as a screw device with a clamp for releasably clamping the power line.

15. The connection system as recited in claim 11 further comprising a cover, the cover containing the second strain-reliever and is configured to at least partially cover the socket apparatus.

16. A charger comprising the connection system as recited in claim 10.

17. A power tool comprising the connection system as recited in claim 10.

18. A socket apparatus comprising at least one socket element for releasable connection to a connection plug for a connection system, the socket apparatus containing a first strain-reliever in order to counteract a tensile load, exerted on the power line, when the connection plug and the socket element are in a connected state.
